(19) United States
(12) Patent Application Publication
(10) Pub. No.: US 2001/0006128 A1
(43) Pub. Date: Jul. 5, 2001

(54) Earthmoving machine

(76) Inventors: Piercarlo Contoli, Faenza (IT); Corrado Ragazzini, Brisighella (IT)

Correspondence Address: Larry W. Miller, New Holland North America, Inc., 500 Diller Avenue, P. O. Box 1895, New Holland, PA, 17557-0903, US

(21) Appl. No.: 09/728,357

(22) Filed: Dec. 4, 2000

(30) Foreign Application Priority Data
Dec. 17, 1999 (IT) BO99A000691

(51) Int. Cl. B60K 11/04

(52) U.S. Cl. 180/68.4; 172/776; 37/466; 280/758; 180/53.1

(57) ABSTRACT

An earthmoving machine wherein a driver's cab and a propulsion device for powering the machine are located on opposite sides of a central lift arm. The propulsion device is provided with a cooling device located over the propulsion device itself.

### BACKGROUND OF THE INVENTION

The present invention relates to earthmoving machines and is particularly advantageous for use on earthmoving machines of the type comprising two axles extending crosswise to a longitudinal axis of the machine and each fitted with two drive wheels; a driver's cab; propulsion means for powering the machine; a lift arm between the cab and the propulsion means; and a cooling assembly for cooling the propulsion means.

The cooling assembly is located between the propulsion means and one of the two axles, and normally comprises a substantially parallelepiped-shaped radiator in turn comprising two parallel major lateral faces perpendicular to the longitudinal axis of the machine, and an impeller mounted facing one of the major lateral faces of the radiator to rotate about a respective axis of rotation substantially parallel to the longitudinal axis.

One drawback of known earthmoving machines of the above type lies in the location of the cooling assembly, which results in a relatively long wheel base—i.e. the distance, measured parallel to the longitudinal axis of the machine, between the two axles—thus reducing maneuverability because of the big turning circle radius of the machine.

Another drawback of known earthmoving machines of the above type lies in the cooling assembly being located fairly close to the ground and the drive wheels, and therefore being fouled relatively easily by dirt thrown up by the drive wheels during operation of the machine.

### SUMMARY OF THE INVENTION

It is an object of the present invention to provide an earthmoving machine designed to eliminate the aforementioned drawbacks.

According to the present invention, there is provided an earthmoving machine comprising a lift arm mounted for rotation about a first axis; a driver's cab; propulsion means for powering the machine, said propulsion means and said cab being located on opposite sides of said lift arm; and cooling means for cooling said propulsion means; characterized in that said cooling means are located substantially over said propulsion means.

These and other objects, features and advantages are accomplished according to the instant invention by providing an earthmoving machine having a driver's cab and a propulsion device for powering the machine which is located on opposite sides of a central lift arm. The propulsion device is provided with a cooling device that is located over the propulsion device itself.

### BRIEF DESCRIPTION OF THE DRAWINGS

The advantages of this invention will become apparent upon consideration of the following detailed disclosure of the invention, especially when taken in conjunction with the accompanying drawings, wherein:

FIG. 1 is a front elevational view of an earthmoving machine incorporating the principles of the instant invention, certain portions of the machine have been removed for purposes of clarity;

FIG. 2 is a side elevational view of the earthmoving machine shown in FIG. 1 with portions being removed for purposes of clarity;

FIG. 3 is a perspective detail view of a first portion of the earthmoving machine shown in FIG. 1, portions being removed for clarity;

FIG. 4 is a perspective detail view of a second portion of the earthmoving machine of FIG. 1; and

FIG. 5 is a partially exploded perspective detail view of the second portion of the earthmoving machine shown in FIG. 4.

### DETAILED DESCRIPTION OF THE PREFERRED EMBODIMENTS

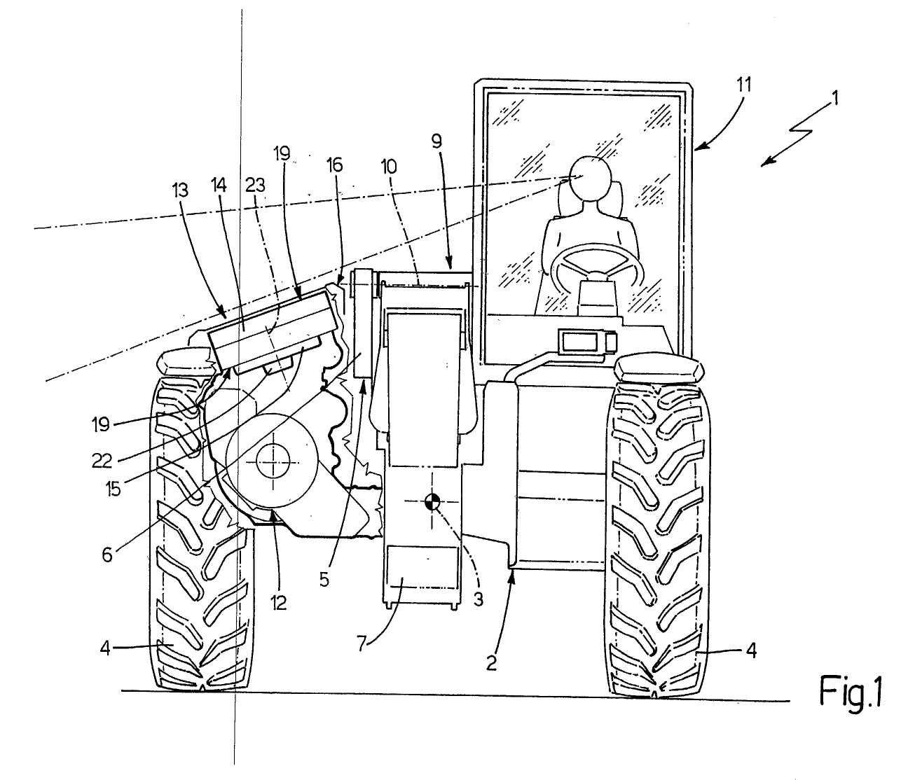

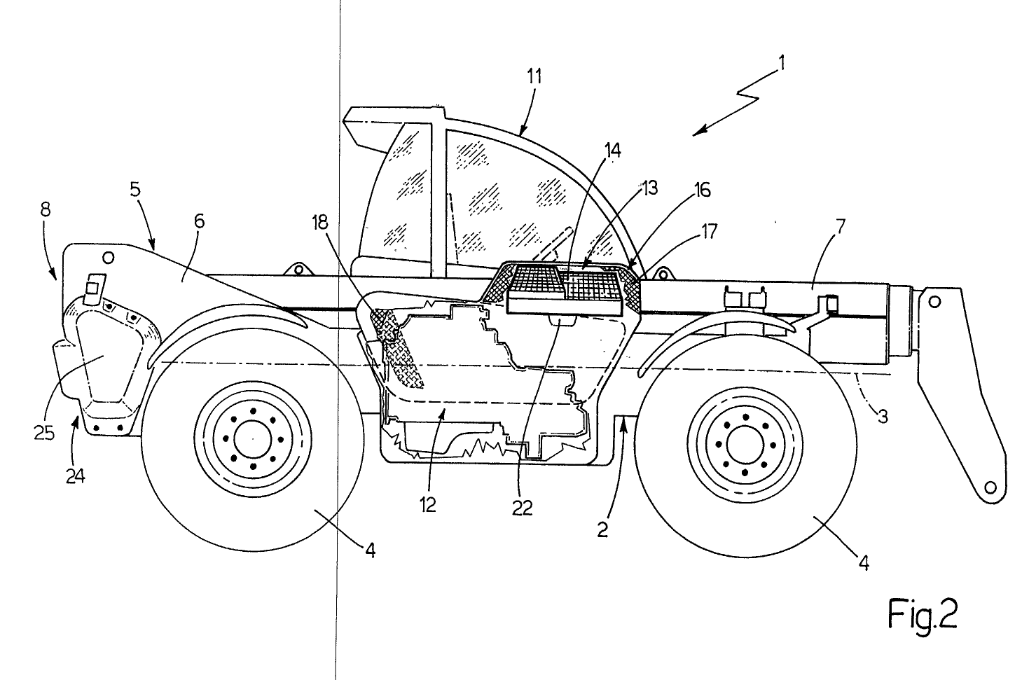

Referring first to the front elevational view of the earthmoving machine incorporating the principles of the instant invention, as depicted in FIG. 1, the earthmoving machine 1 includes a frame 2 having a longitudinal axis 3 and supporting two conventional axles (not shown) extending crosswise to axis 3, with each axle supporting two opposing drive wheels 4.

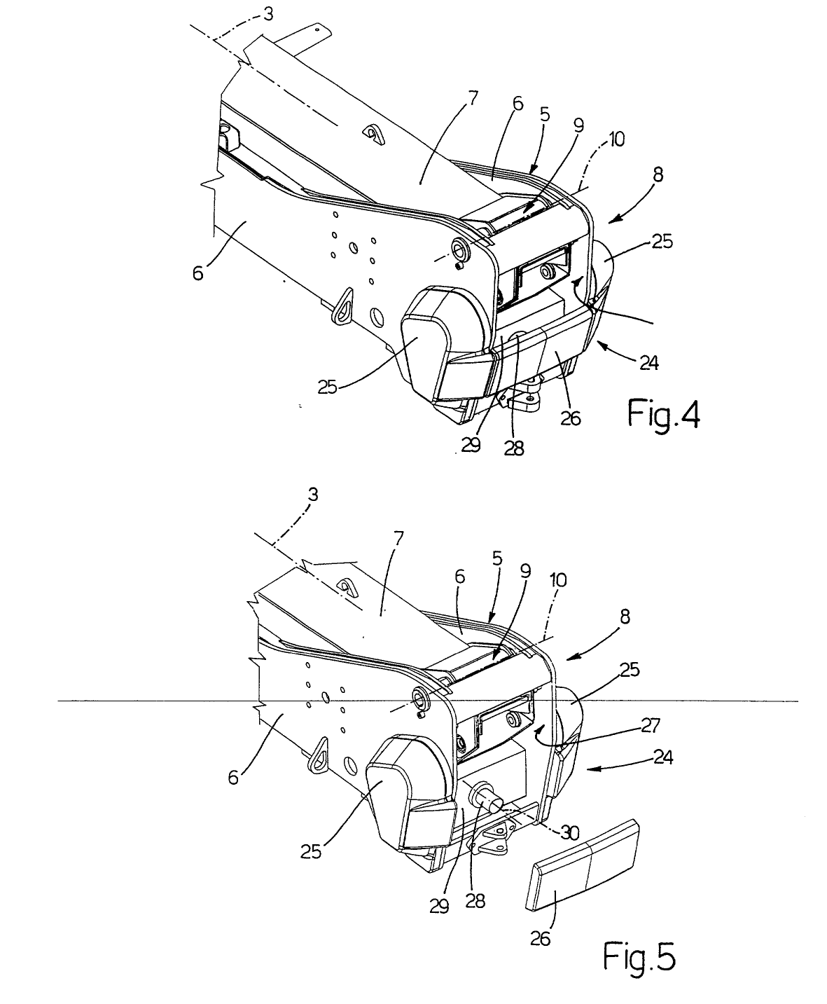

The earthmoving machine 1 is also provided with a central supporting member 5 fixed to the frame 2 and is formed from two parallel elongated plates 6 oriented parallel to and on either side of the axis 3. Furthermore, the earthmoving machine 1 is provided with a telescopic lift arm 7 hinged to a rear end 8 of member 5, as best seen in FIGS. 4 and 5, to swing, with respect to member 5 by virtue of a conventional actuating device 9, such as a hydraulic motor, about an axis 10 oriented substantially crosswise to axis 3.

The earthmoving machine 1 also includes a driver's cab 11 to the side of arm 7; and an engine 12 for powering the earthmoving machine 1. The engine is preferably located between the wheels 4 and on the opposite side of arm 7 from the cab 11.

The engine 12 has a longitudinal axis 12a substantially parallel to axis 3, and a cooling assembly 13 located over the engine 12. The cooling assembly 13 includes a radiator 14 and an impeller 15, both of which are housed, together with engine 12, inside a casing 16 including an air inlet grille 17 and three air outlet grilles 18.

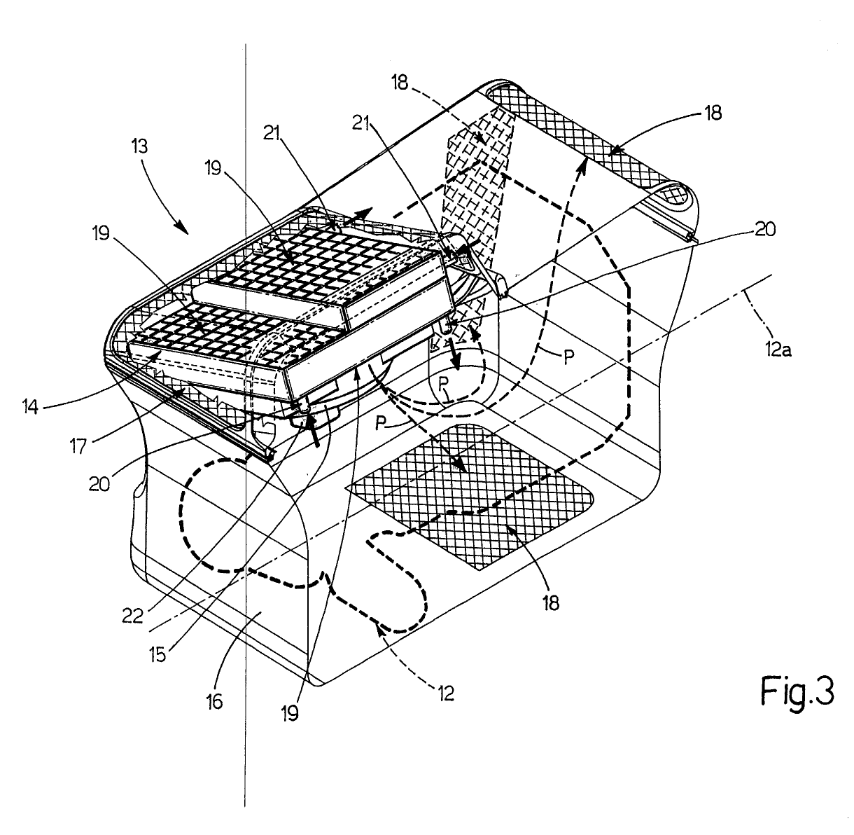

With reference to FIGS. 1 and 3, the radiator 14 is positioned facing grille 17, and is formed in a substantially parallelepiped-shape. The radiator 14 has two parallel major lateral faces 19 and is fitted to the frame 2 so that the two faces 19 form an angle of other than zero with respect to the axis 10. More specifically, the two faces 19 slope downwardly from the central member 5 to prevent the cooling assembly 13 from blocking the view of the driver when positioned inside of the cab 11, and also to prevent an excessive amount of dirt from depositing on the cooling assembly 13 itself.

The radiator 14 forms part of a hydraulic circuit 20 for cooling the engine 12, and of a pneumatic circuit 21 for cooling the intake air of the engine 12.

The impeller 15 is located between the radiator 14 and the engine 12. The impeller 15 is mounted to rotate with respect to radiator 14 by virtue of a known actuating device 22, such as a hydraulic motor, about an axis 23 substantially perpendicular to the two faces 19. In this connection, it should be noted that the impeller 15 provides for feeding the air inside the casing 16 along a path P, best seen in FIG. 3, extending between the grille 17 and the three grilles 18, so as to cool the radiator 14 and also assist in cooling the engine 12.

The earthmoving machine 1 also includes a balancing device 24, best seen in FIGS. 4 and 5, for balancing the weight of the arm 7. The balancing device 24 is preferably located at the end 8 and is formed from two fixed counterweights 25 fitted to the outside of the plates 6 on either side of the axis 3, and a counterweight 26 fitted removably to the member 5 between the two counterweights 25 and crosswise to the axis 3. When fitted to the member 5, counterweight 26 defines a rear housing 27 at the end 8, between the plates 6 and beneath the arm 7, to house a power takeoff 28 mounted for rotation with respect to the member 5 by virtue of a known actuating device 29, such as a hydraulic motor, about a respective longitudinal axis 30 substantially parallel to the axis 3.

The location of cooling assembly 13 provides for obtaining a relatively short wheel base of machine 1, i.e. the distance measured parallel to axis 3, between the axles (not shown), which improves the maneuverability of machine 1 by reducing the turning circle radius as compared to the earthmoving machines known in the prior art. Moreover, the off-ground height of cooling assembly 13 prevents an excessive amount of dirt thrown up by the drive wheels 4 during operation of the earthmoving machine 1 from coming into contact with the radiator 14 and the impeller 15.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

Having thus described the invention, what is claimed is:

1. In an earthmoving machine having a lift arm mounted for rotation about a first axis; a driver's cab; an engine for powering the operation of the machine, said engine and said cab being located on opposite sides of said lift arm; and cooling mechanism for cooling said engine, the improvement comprising:
said cooling mechanism being located substantially over said engine.

2. The earthmoving machine of claim 1 wherein said cooling mechanism comprises a substantially parallelepiped-shaped radiator having two substantially parallel major lateral faces, said first axis forming an angle greater than zero degrees with respect to said major lateral faces.

3. The earthmoving machine of claim 2 wherein said major lateral faces slope outwards of the machine.

4. The earthmoving machine of claim 2 wherein said cooling mechanism also comprises an impeller mounted for rotation about a second axis substantially perpendicular to said major lateral faces.

5. The earthmoving machine of claim 4 further comprising a casing housing said cooling mechanism and said engine, said impeller feeding the air in the casing along a predetermined path, said engine being located along the predetermined path.

6. The earthmoving machine of claim 5 further comprising a power takeoff mounted for rotation about a third axis substantially perpendicular to said first axis.

7. The earthmoving machine of claim 6 wherein said power takeoff is located at a rear portion of said earthmoving machine, said third axis extending substantially longitudinally.

8. The earthmoving machine of claim 7 further comprising a balancing mechanism for balancing the weight of said lift arm, said balancing mechanism including at least one counterweight removably mounted on the earthmoving machine at said rear portion.

9. The earthmoving machine of claim 8 further comprising a housing supporting said lift arm at said rear portion, said counterweight defining a rear portion of said housing.
